(19) United States
(12) Patent Application Publication
(10) Pub. No.: US 2025/0358923 A1
(43) Pub. Date: Nov. 20, 2025

(54) LIGHTNING PROTECTION DEVICE FOR ELECTRONIC EQUIPMENT ON TOWER

(71) Applicants: Jian Zhang, Zhejiang (CN); Hua Zhang, Zhejiang (CN); Jinglun Zhang, Zhejiang (CN)

(72) Inventors: Jian Zhang, Zhejiang (CN); Hua Zhang, Zhejiang (CN); Jinglun Zhang, Zhejiang (CN)

(21) Appl. No.: 18/291,926

(22) PCT Filed: Sep. 15, 2023
(86) PCT No.: PCT/CN2023/119015

§ 371 Date: Jan. 14, 2025

(30) Foreign Application Priority Data
Sep. 29, 2022 (CN) 202211201114.3

(51) Int. Cl. H05F 3/02

(52) U.S. Cl. CPC H05F 3/02

(57) ABSTRACT

A lightning protection device for electronic equipment on a tower comprises a lightning charge insulating block mounted at the top of a power; a ground insulation lightning arrester which is a metal conductor, arranged at the top of the lightning charge insulating block, and insulated from a tower body; a lightning pulse energy consumption and absorption device comprising capacitive electrode plates, a polar dielectric and an insulating tank container, the capacitive electrode plates being symmetrically mounted on two sides of the interior of the insulating tank container, the insulating tank container being filled with the polar dielectric; and a double-conductor coaxial cable connected to the ground insulation lightning arrester and one end of the lightning pulse energy consumption and absorption device, the other end of the lightning pulse energy consumption and absorption device being connected to a grounding terminal.

### TECHNICAL FIELD

The invention relates to the technical field of lightning protection and high-voltage engineering, in particular to a lightning conductor system device capable of absorbing and consuming lightning energy.

### DESCRIPTION OF RELATED ART

Lightning is a natural phenomenon of intense discharge of the atmosphere within a short time and occurs about 8,000,000 times on average, every day, worldwide. Each flash of lightning releases about 5.5×10⁶ J/Ω energy in an instant within the microsecond range. Lightning poses a great threat to natural resources indispensable for the survival of humans and material civilization created by humans. For example, over 50% of forest fires are caused by lightning; residential buildings for humans are frequently destroyed by lightning; disastrous accidents are often caused to power facilities, traffic facilities, petrochemical facilities and other industrial facilities by lightning.

In the recent over 200 years, the lightning conductor invented by Franklin has been used for lightning protection. The lightning conductor can induce a lightning electric field distortion to attract lightning thereto, so as to protect an object against lightning. Although the lightning conductor can effectively attract lightning, its protection effect is still unsatisfactory. First, the excessively high induced voltage of the lightning conductor is harmful, and when the lightning arrester is struck by lightning, a powerful induced electromagnetic field will be generated around due to severe electromagnetic oscillations and will result in damage to heavy-current and weak-current equipment. Second, the lightning conductor is particularly likely to generate a reverse breakdown voltage and cannot be used for protecting inflammables, explosives and weak current equipment because an explosion will be caused when the inflammables and explosives encounter sparks generated by induction around the lightning conductor, leading to a great loss.

A switch-type charge-amplifier plasma lightning protection system, Patent No.CN03103706.2, adopts the plasma technique, but it needs to be equipped with a high-voltage power supply to generate plasma charges of a different polarity to neutralize lightning.

A self-energy consumption comprehensive line lightning protection device, Patent No.201810747456.2, is designed in a consumption circuit composed of inductance coils and capacitors. According to existing high-voltage capacitor fabrication process, if 100 kV/0.1 uF capacitors are used, thousands of 100 kV capacitors have to be connected in series to be prevented against breakdown because the voltage of lightning is as high as 100 million to 1 billion volts. In actual lightning protection engineering, such a huge cost is unsustainable, making it unpractical to use capacitors to absorb lightning.

An arc-extinction lightning protection method based on the electrohydraulic effect and the Pascal's principle, Patent No. 202110909447.0, uses insulating oil to realize the electrohydraulic effect to absorb lightning energy, that is, when an insulating dielectric between electrodes discharges, a high-voltage electric field breaks down the insulating oil to form a breakdown channel, and energy is realized through oil gasification, carbonization and pressure expansion. However, this method has the drawback that the insulating performance of the insulating oil will be reduced after initial breakdown of the insulating oil by lightning, shortening the service life.

Existing lightning conductor systems have the following technical problems:

The lightning conductor can attract lightning, and after lightning is attracted to a lightning arrester, a large lightning current will flow into the ground along the lightning conductor and powerful electromagnetic pulses will be generated at the same time, but effective energy consumption and absorption cannot be realized.

When lightning is attracted to the lightning conductor, a high-frequency current of thousands of amperes will pass through the lightning conductor, and a down lead and grounding device thereof. Due to the lack of energy absorption, the voltage of the lightning conductor and the lead will be extremely high, and if the distance between the lightning conductor and a protected object is less than a safe distance, a reverse breakdown overvoltage will be applied to the protected object from the lightning conductor and the down lead, causing damage to protected computers and communication equipment. The use of a high-frequency current channel made from pure ion will lead to an electrical high-impedance obstruction, making overvoltage hazards occur more easily.

### SUMMARY

The objective of the invention is to overcome the drawbacks in the prior art by designing a low-impedance channel allowing high-frequency lightning pulses to pass through at the top of an original tower, iron tower or lightning conductor to lead the lightning pulses through a high-voltage coaxial cable to a lightning pulse energy consumption and absorption device to realize lightning pulse energy absorption and consumption.

The above objective of the invention is fulfilled through the following technical solution:

A lightning protection device for electronic equipment on a tower comprises: a lightning charge insulating block mounted at the top of a tower (Franklin's lightning conductor) and made from a high-voltage insulating material, and a metal ground insulation lightning arrester arranged at the top of the lightning charge insulating block, wherein the ground insulation lightning arrester is isolated from a tower body by the lightning charge insulating block and connected through a double-conductor coaxial cable to one end of a lightning pulse energy consumption and absorption device mounted near the ground, the other end of the lightning pulse energy consumption and absorption device is connected to a grounding terminal, the lightning pulse energy consumption and absorption device comprises capacitive electrode plates, a polar dielectric and an insulating tank container, the capacitive electrode plates are symmetrically mounted on two sides of an interior of the insulating tank container, the insulating tank container is filled with the polar dielectric, and a high-frequency pulse effect is generated by means of relaxation features of a polarization effect of a dielectric material in the polar dielectric to generate a dipole polarization loss in the polar dielectric to consume lightning field energy; the lightning charge insulating block is a high-voltage insulator or a bushing high-voltage insulator, the insulator is a ceramic insulator or a silicone rubber composite insulator and is able to withstand a voltage over 100 kV, the ground insulation lightning arrester is a metal conductor rod which may be a solid or hollow conductor such as an iron bar, stainless steel rod, a copper bar or an aluminum bar, is mounted at the top of the lightning charge insulating block, and is insulated from a ground potential G, the double-conductor coaxial cable has low resistance and is non-inductive as compared with common wires, and the two conductors of the double-conductor coaxial cable are capacitive.

Preferably, the double-conductor coaxial cable comprises, from inside to outside, four layers: an inner core conductor, an intermediate insulating layer, an outer core conductor and an outer insulating layer; and one end of the inner core conductor is connected to an end of the ground insulation lightning arrester, the other end of the inner core conductor is connected to said end of the lightning pulse energy consumption and absorption device, and the outer core conductor is connected to the grounding terminal. The inner core conductor is a copper core or an aluminum core; because of the high lightning voltage, the intermediate insulating layer is made from polyethylene or crosslinked polyethylene capable of withstanding a high voltage of 50-100 kV; the outer core conductor is made from copper; and the outer insulating layer is made from a plastic-clad material.

Preferably, the polar dielectric has a dielectric constant εᵣ≥50.

Preferably, the polar dielectric is prepared by mixing solid particles with a dielectric constant εᵣ≥100 and a liquid phase with a dielectric constant εᵣ≥40.

Preferably, the liquid phase is one or a combination of two or more of water, saline water and propylene carbonate.

Preferably, the solid particles are prepared by mixing one, two or more of barium titanate, calcium titanate and calcium copper titanate; or, the solid particles are prepared by mixing any one, two or more of barium titanate, calcium titanate and calcium copper titanate with one, two or more of clay, kaoline and gypsum. Barium titanate, calcium titanate and calcium copper titanate are all strong dielectric compound materials and have a high dielectric constant, and can be mixed and one, two or more of clay, kaoline and gypsum to reduce the cost under the precondition of guaranteeing a desired dielectric constant.

Preferably, the ratio of a volume fraction of the solid particles to a volume fraction of the liquid phase is 1:1˜1:15.

Preferably, the solid particles further comprise a ferromagnetic material, and the dielectric containing the ferromagnetic material absorbs the lightning field energy and then converts the lightning field energy into magnetic field energy to realize an electric energy absorption and consumption process, together with an expansion or pressure change of a magnetic liquid.

Preferably, the ferromagnetic material is prepared by mixing one, two or more of ferrite powder, ferroferric oxide powder, seignette salt and potassium dihydrogen phosphate.

According to the invention, a ground insulation lightning arrester is arranged at the top of an original tower, iron tower or lightning conductor, lightning pulses are led to a lightning pulse energy consumption and absorption device through a low-impedance channel construed by a double-conductor coaxial cable; the non-inductive (capacitive only) lightning arrester of the lightning conductor can prevent protect communication equipment nearby against severe destruction caused by R-L-C high-frequency resonance resulting from lightning electromagnetic pulses in the lightning conductor and a ground capacitor, and a high-frequency pulse effect is generated by means of relaxation features of a polarization effect of a dielectric material in a polar dielectric to generate a dipole polarization loss in the polar dielectric to consume lightning field energy, such that the lightning field energy can be effectively consumed, decreasing the potential and lightning current of a lightning residual voltage at the bottom of the lightning conductor. generally from 5 kA-50 kA to hundreds of amperes, and guaranteeing the safety of electronic and electrical equipment around the tower body; lightning pulse energy is absorbed based on dielectric polarization, at this moment, the dielectric has not yet been broken down by the high lightning voltage due to the physical form of corona discharge of the liquid dielectric, and the insulating performance of the dielectric is protected and will not be affected by a free dielectric formed after breakdown, and thus the dielectric can be used repeatedly, has a long service life, and can keep the lightning energy consumption capacity unchanged in many years, thus improving the economic performance and durability of the device; and the invention only has a requirement for the absorption capacity of the lightning pulse energy consumption and absorption device, and has no requirement for the grounding resistance (<5-10Ω, required by national regulations), thus reducing the investment cost for connecting the tower to a grounding grid.

### BRIEF DESCRIPTION OF THE DRAWINGS

FIG. 1 is a structural diagram of a system device according to the invention.

FIG. 2 is a structural diagram of a lightning pulse energy consumption and absorption device according to the invention.

### DESCRIPTION OF THE EMBODIMENTS

The technical solutions of the embodiments of the invention will be clearly and completely described below in conjunction with drawings of these embodiments. Obviously, the embodiments in the following description are merely illustrative ones, and are not all possible ones of the invention. All other embodiments obtained by those ordinarily skilled in the art according to the following ones should also fall within the protection scope of the invention,

The design purpose of the device is, independent of the process of absorbing and consuming lightning energy by a grounding grid, to arrange a ground insulation lightning arrester to avoid a large current formed by a direct short-circuit between ground charges and charges in the air, and a lightning pulse energy consumption and absorption device arranged on the capacitive lightning arrester of the lightning conductor can effectively avoid high-frequency oscillations of lightning and absorb over 95% of lightning pulse energy.

The principle of the lightning arrester of the lightning conductor is as follows:

A traditional tower-type Franklin's lightning conductor is typically made from iron and has a large inductance, which can be calculated by the following formula:

$$L = \frac{{N}^{2} BA}{Hl} = \frac{{N}^{2} {U}_{r} {U}_{0} A}{l}$$

Where, N is the number of turns, Ur is the permeability, U₀ is the air conductivity and is 4π×10⁻⁷, A is the cross-sectional area of a tower body, and L is the length a magnetic loop per unit.

In a case where the tower body is made from angle iron with a height of 30 M and a cross-section area of 2 m², the inductance L of the tower body is calculated as follows:

$$L = \frac{{N}^{2} {U}_{r} {U}_{0} A}{l} = \frac{{1}^{2} \times 1.6 \times 1 {0}^{3} \times 4 π \times 1 {0}^{- 7} \times 10}{1} = 20 \times 1 {0}^{- 3} H = 20 mH ( \frac{A}{l} = 10 )$$

According to the traveling wave impedance principle in High Voltage Engineering, the impedance of common wires is about Z=500Ω, and the impedance of a coaxial cable is Z=20Ω-50Ω, and assume the impedance of the iron tower body is still 500Ω, the inductance L of the iron tower is calculated by reverse deduction.

$$Z = 2 π fL = 500 Ω , L = \frac{500}{2 π f} , f = 4 kHz , \frac{500}{2 π \times 4 \times 1 {0}^{3}} = 1 9.9 \approx 20 mH$$

Therefore, the inductance of the tower body of the lightning conductor is about 20 mH, indicating that the tower body of the lightning conductor is inductive.

The calculated inductance of the iron tower is close to the inductance calculated by formula

$$L = \frac{{N}^{2} BA}{Hl} ,$$

indicating the iron tower has a considerable inductance.

In the presence of a large area of water in soil, an equivalent capacitance C between two electrodes is considerable. Assuming the length of a water area between a first falling point of charges in rainwater in the air and a discharge grounding point of charges of a different polarity at the bottom of the tower (second falling point) is 100 m, it is speculated, according to the volume fraction of an empirical value in the test process, that the equivalent capacitance between the two electrodes is 0.5 μF-50 μF. In case of a continual rainstorm in the water area, the equivalent capacitance is C=1 μF-2 μF and will form an oscillation circuit together with the equivalent inductance L of the iron tower, and according to the R-L-C resonance formula:

$$f = \frac{1}{2 π \sqrt{LC}} = \frac{1}{2 π \sqrt{20 \times 1 {0}^{- 3} \times 1 \times 1 {0}^{- 6}}} = 1.12 \times 1 {0}^{3} Hz = 1.12 KHz$$

Lightning wave energy is mainly concentrated within a frequency band of 1 kHz and accounts for over 70% of total pulse energy, and 90% of the lightning wave energy has a bandwidth of 1-30 kHz.

An oscillation source circuit is formed by an R-L-C equivalent circuit consisting of the inductance L of the lightning conductor, the capacitance C of soil containing water, and the resistance R of the ground, and high-frequency lightning pulses, the oscillating frequency

$$f = \frac{1}{2 π \sqrt{LC}}$$

exactly falls within the high-amplitude frequency band of lightning. According to the formula of the quality factor

$$Q = \frac{{ω}_{0} L}{R} ,$$

an L-C circuit will amplify lightning energy by tens to hundreds of times. When the frequency of lightning waves is 1.12 kHz, the oscillating current and voltage generated will be significantly amplified, and the quality factor of oscillation is generated by the amplification factor, where R is the equivalent resistance of the ground, and the amplification factor will increase with the decrease of the grounding resistance. So, the waves have a large vibration amplitude within 1-4 kHz and will produce a strong oscillating destructive force at this frequency, causing significant destruction to electronic communication equipment nearby.

In view of this, a non-inductive lightning arrester of the lightning conductor is designed to prevent R-L-C high-frequency resonance, and the capacitive lightning arrester can effectively avoid high-frequency oscillations of lightning.

The theoretical basis and principle of the lightning pulse energy consumption and absorption device:

1. In addition to displacement polarization, a polar liquid dielectric also has significant dipole orientation polarization. The dipole polarization and loss theory proposed by Debye believes that the movement of polar liquid molecules can be considered as “frictional” rotation of solid pellets with a radius a in a viscous medium with a macroscopic viscosity η. According to the Stoke's law, the frictional coefficient of liquid is ξ=8πηa². In a polar liquid or solution, in absence of an external electric field, the direction of the dipole moment of each polar molecule is disordered due to Brownian movement, and there is no dipole moment on the whole. In presence of an external electric field, because the frictional resistance with molecules around is counteracted, the rotating force of the polar molecules and the force of Brownian movement form a resultant force to lead to a change of the state, and there is an induced dipole moment in the electric field direction. According to condition that the rotating torque and frictional torque of dipoles in an electric field are in balance, the relaxation time under a weak electric field can be calculated (the frictional coefficient ξ=8πηa² is substituted):

$$τ = \frac{ξ}{2 kT} = \frac{4 πη {a}^{2}}{k T}$$

The intensity of dipole polarization of the polar liquid dielectric is:

$$P = {Na}_{d} E$$

Dipole orientation polarization is a typical relaxation polarization, and the loss power of the dipole orientation polarization is:

$${P}_{τ} = {ε}_{0} ( {ε}_{τ} - {ε}_{m} ) E = {Na}_{d} E = \frac{N {μ}_{0}^{2}}{3 kT} E$$

The loss power in unit volume of the dielectric under a high frequency is:

$$P = ω {ε}_{0} {εE}^{2} tg δ = 2 π {fCU}^{2} tg δ$$

The dielectric constant ε of the polar liquid dielectric changes with the change of the electric field frequency, and the basic principle of the invention is to absorb electric field energy of lightning in the dielectric loss process of dipolar polarization of plasma.

### 2. Analysis of the Mechanism Process of Discharge of the Polar Dielectric and Trichel Pulses

During discharge of the polar dielectric consisting of polar molecules, the initial stage of negative corona discharge is Trichel pulse discharge caused by the Trichel effect. “Negative” means that a liquid, gas molecule or atom has a high affinity to electrons. When a voltage applied to a corona electrode (generally referring to an electrode with a small curvature radius) exceeds an initial voltage, the electric field in the vicinity of the surface of the corona electrode will exceed an ionized threshold electric field, producing polarization. Trichel pulses are similar to high-frequency pulses of bursting, and this similarity is reflected most obviously at the beginning of the generation of the Trichel pulses. At this moment, the current pulse shows a steep front edge, multiple different peaks occur at the same time, and the frequency of the Trichel pulses is f=10 KHz-250 KHz.

### 3. Lightning Energy Conversion Process of the Polar Dielectric Added With Magnetic Particles

(1) The magnetorheological fluid is a suspension formed by dispersing magnetizable solid particles in a liquid phase, and because of the different in permeability μ of the particles and a base solution, the particles will be excited under the action of an external electric field E. The polarization of the magnetorheological fluid can be approximated by a magnetic dipole model. If the acting force between dipoles is large enough, the particles will gather together to form a chain or may further form a columnar shape or other structures, thus realizing solid-liquid separation. Such a change in structure will lead to a significant change of the viscosity of the suspension, and energy absorption and consumption are involved in the change process. This process can be completed in an instant (ms), is reversible, and has good repeatability.

(2) When a lightning electric field acts on a polar dielectric containing magnetic ferrite particles, the magnetization intensity M of the magnetic liquid can be expressed as:

$$M = nm ( coth ξ - \frac{1}{ξ} ) = {M}_{s} {L}^{ξ} ( ξ )$$

Where, =μ₀mH/(K₀T), in which both the temperature T and the magnetic field intensity H included. So, the magnetization intensity M of the magnetic liquid is a function of the magnetic field intensity and the temperature and is also a function of the volume fraction ø of the magnetic solid particles. The specific volume V_{f} of the magnetic liquid is related to ø, so

$$M = M ( T , H , {V}_{f} )$$

The magnetic induction intensity B in the magnetic liquid is:

$$B = {μ}_{0} ( H + M )$$

For the magnetic liquid, the direction of sold particles can be easily kept consistent with the direction of the external magnetic field after the sold particles are magnetized. The three vectors B, H and M can be kept in parallel, and the permeability u of the magnetic liquid can be expressed as:

$$M = {μ}_{0} ( 1 + \frac{M}{H} )$$

It can be obviously seen, from the above relationship, that B and u are both functions of T, H and V_{f}, that is:

$$B = B ( T , H , {V}_{f} ) , μ = μ ( T , H , {V}_{f} )$$

(3) In a case where the magnetization intensity M of the magnetic liquid is in direct proportion to the external magnetic field intensity H

Assuming the three vectors B, H and M in the magnetic liquid are parallel,

$$B = {μ}_{0} ( H + M ) = μ H$$

so

$${μ}_{0} M = ( μ - {μ}_{0} ) H$$

Under a normal circumstance, a functional relationship between the magnetization intensity M and the permeability μ is:

$$M = M ( T , V , H ) , μ = μ ( T , V , H )$$

For a linear magnetization process where the magnetization intensity M of the magnetic liquid in direct proportion to the external magnetic field intensity H, the permeability μ only depends on the specific volume v and has no connection with the external magnetic field intensity H.

(4) From the perspective of thermodynamics, work of the magnetic liquid is work generated by volume changes, that is pdv. In the presence of an external magnetic field, work applied by the external magnetic field to the magnetic liquid includes two parts: one part is work for increasing the magnetic field intensity in the magnetic liquid from 0 to H, and the other part is work for magnetizing the magnetic liquid (magnetization work). So, the work applied by the external magnetic field to the magnetic liquid is

$$W = {v}_{0} {\int }_{0}^{B} H \cdot dB ,$$

where V₀ is the volume faction, B is the magnetic induction intensity, and H is the magnetic field intensity.

Elementary work applied by the magnetic liquid per unit mass to the outside is:

$$dW = pdv - d ( v {\int }_{0}^{B} HdB )$$

Where, p is the magnetization pressure of the magnetic liquid.

$$P = {μ}_{0} {\int }_{0}^{H} HdB$$

P is the pressure caused by a volume change of the magnetic liquid in the magnetic field, also referred to as magnetostriction pressure.

Where, pdv is expansion work of the magnetic liquid and is applied by the magnetic liquid to the outside.

It can be known, from the above analysis, that by using the magnetic particles, the magnetic polar dielectric can absorb lightning field energy and then convert the lightning field energy into magnetic field energy to realize an electric energy conversion process, together with the expansion the magnetic liquid.

### Values of Related Technical Parameters of Lightning Energy

TABLE 1
Typical values, maximum values and minimum values
of discharge of cloud-to-ground lightning

| | | Minimum | Typical | Maximum |
|---|---|---|---|---|
| Parameters | | value | value | value |
| Initial breakdown | | | | |
| Duration (ms) | | | 100 | |
| Step leader | | | | |
| Step length (m) | | 3 | 50 | 200 |
| Time interval between steps (μs) | | 30 | 50 | 125 |
| Average propagation velocity of step leader (m/s) | | 1.0 × 10⁵ | 3.0 × 10⁵ | 2.6 × 10⁵ |
| Charge stored in step channel (C) | | 3 | 5 | 20 |
| Arrow (dart) leader | | | | |
| Propagation velocity (m/s) | | 1.0 × 10⁶ | 2.0 × 10⁶ | 2.1 × 10⁷ |
| Accumulative charge in arrow leader channel (C) | | 0.2 | 1 | 6 |
| Return stroke | | | | |
| Propagation velocity (m/s) | | 2.0 × 10⁷ | 5.0 × 10⁷ | 2.0 × 10⁸ |
| Current increasing rate (kA/μs) | | 1 | 10 | 210 |
| Peak current (kA) | | 1 | 30 | 250 |
| Peak current time (μs) | | 0.5 | 2 | 30 |
| Half-peak current time (μs) | | 10 | 40 | 250 |
| Charge transfer without continuous current (C) | | 0.2 | 2.5 | 20 |
| Temperature (K) | | 0.8 × 10⁴ | 2 × 10⁴ | 3.0 × 10⁴ |
| Electron density (m³) | | 1.0 × 10²³ | 3.0 × 10²³ | 3.0 × 10²⁴ |
| Channel length (km) | | 2 | 5 | 14 |
| Continuous current | | | | |
| Peak current (A) | | 30 | 150 | 1600 |
| Duration (ms) | | 50 | 150 | 500 |
| Charge transfer | | 3 | 25 | 330 |
| Lightning | | | | |
| Number of strokes of each flash of lightning | | 1 | 3 | 26 |
| (count) | | | | |
| Time between two flashes of lightning without | | 3 | 40 | 380 |
| continuous current (ms) | | | | |
| Lightning duration (s) | | 0.01 | 0.3 | 2 |
| Charge transfer with continuous current | | 1 | 20 | 400 |
| J process | duration (ms) | 30 | 60 | 200 |
| | development speed(m/s) | 1 × 10⁵ | 10 × 10⁵ | 30 × 10⁵ |
| | transferred charge (C) | 2.4 | 3 | 3.4 |
| | electric moment (C · km) | 1 | 8 | 16 |
| K process | duration (ms) | 0.1 | 1 | 2.7 |
| | interval (ms) | 1 | 5 | 33 |
| | electric moment (C · km) | 0.01 | ~10⁻¹ | 1 |
| C process | duration (ms) | 50 | 150 | 500 |

| | |
|---|---|
| Total charge (C) | 53.5 |

The specific implementation of the device of the invention is as follows:

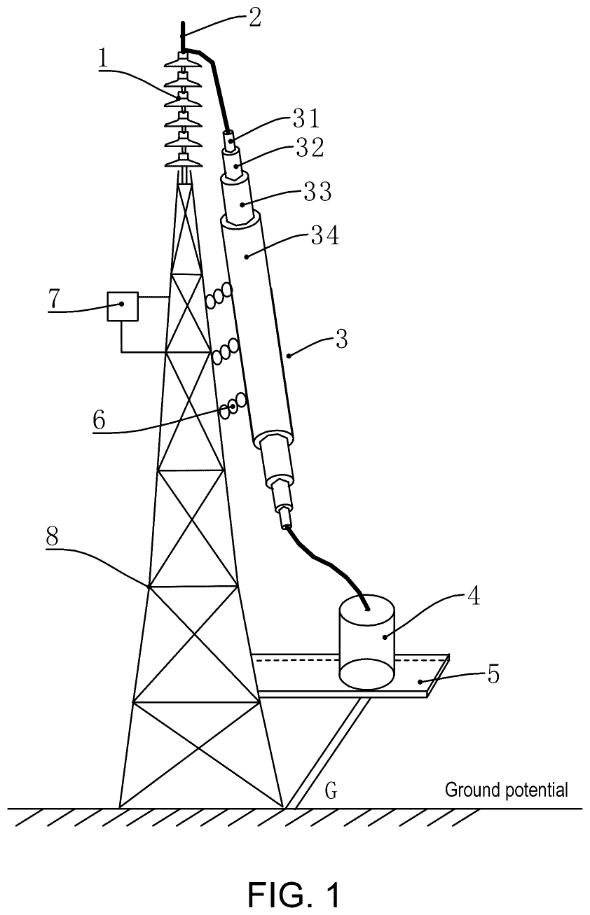

As shown in FIG. 1, a lightning protection device for electronic equipment on a tower 8 comprises: a lightning charge insulating block 1 mounted at the top of the tower (Franklin's lightning conductor) and made from an insulating material, and a metal ground insulation lightning arrester 2 arranged at the top of the lightning charge insulating block 1, wherein the ground insulation lightning arrester 2 is insulated from a tower body by the lightning charge insulating block 1 and connected through a double-conductor coaxial cable 3 to one end of a lightning pulse energy consumption and absorption device 4 installed near the ground, and the other end of the lightning pulse energy consumption and absorption device 4 is connected to a grounding terminal.

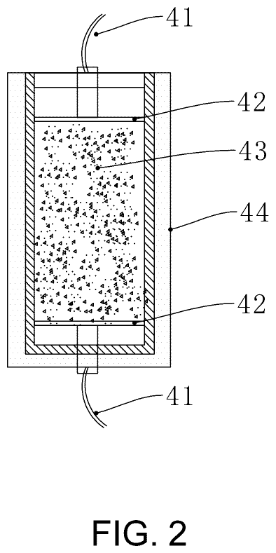

As shown in FIG. 2, the lightning pulse energy consumption and absorption device 4 comprises two capacitive electrode plates 42 which are arranged opposite to each other, a polar dielectric 43 solution prepared from polar molecules, and an insulating tank container 44, wherein the capacitive electrode plates 42 are symmetrically mounted on two sides of the interior of the insulating tank container 44, the polar dielectric 43 solution is contained in the insulating tank container 44, and the insulating tank container 44 is filled with the polar dielectric 43 solution, the capacitive electrode plates 42 are completely immersed in the liquid-phase polar dielectric 43 solution, two ends of the capacitive electrode plates 42 are connected to a lightning inlet end or an upper end of the lightning conductor and the grounding terminal through leads 41 respectively, or upper and lower ends of the lightning pulse energy consumption and absorption device 4 are connected to a charged terminal and a grounding terminal of protected electrical equipment respectively after the lightning pulse energy consumption and absorption device 4 is connected in series with a zinc oxide arrester; after lightning enters the consumption and absorption device, a Trichel high-frequency pulse effect is generated by means of relaxation features of a polarization effect of a dielectric material in the polar dielectric 43 solution in the consumption and absorption device to generate a dipole polarization loss in the polar dielectric 43 solution to consume lightning field energy, such that the impact current of lightning discharge can be greatly decreased, from a 20 kA-50 kA discharge current to a current of hundreds of amperes, and the residual voltage of the tower body is significantly decreased; and lightning pulse energy is absorbed based on dielectric polarization, at this moment, the dielectric has not yet been broken down by the high lightning voltage due to the physical form of corona discharge of the liquid dielectric, and the insulating performance of the dielectric is protected and will not be affected by a free dielectric formed after breakdown, and thus the dielectric can be used repeatedly, has a long service life, and can keep the lightning energy consumption capacity unchanged in many years, thus improving the economic performance and durability of the device.

The expression of the capacitance of a capacitor is:

$$C = \frac{{ε}_{0} {ε}_{r} s}{d} ,$$

where εᵣ is a relative dielectric constant between the two plates, d is the distance between the two plates, and S is the area between the two plates.

Because the lightning voltage is as high as U=10⁸˜10⁹ V (Volt), it can be known, from Table 1, that the leader charge of lightning is averagely q=50 (Coulomb),

$$C = \frac{Q}{U} = \frac{5}{1 {0}^{8}} = 5 \times {10}^{- 8} F = 50 nF ,$$

and according to Q=U·C, the voltage of a lightning falling point will decrease in the same proportion when the capacitance C of a reception point increases; because the capacitance of the leader charge of the lightning source side is C=50 nF, if the capacitance of an absorption point is designed into C=200 uF, 1 uF=1000 nF, the capacitance is increased by 4,000 times, and the voltage will be decreased from 10⁸ V to

$${U}_{2} = \frac{1 {0}^{8}}{4000} = 25 ;$$

if the resistance of a lightning eliminator is designed into 500Ω, the current across the lightning eliminator is

$$I = \frac{25 kV}{500} = 50 A ,$$

at this moment, the lightning eliminator decreases the lightning current from 50 kA to 50 A and decreases the lightning voltage from 10⁵ kV to 25 kV under the action of a high-voltage large-capacity resistor RC, that is, the voltage is decreased by 4,000 times, greatly reducing damage to equipment nearby.

In a case where the lightning pulse energy is A=10⁷ and an absorbing medium prepared from any one, or by mixing two or more of barium titanate, calcium titanate and calcium copper titanate with a high dielectric constant is used as solid particles of the polar dielectric, because the dielectric constant εᵣ of calcium titanate is as high as 100, according to the calculation formula of C:

$$C = \frac{{ε}_{0} {ε}_{r} s}{d} ,$$

when the area S of the capacitive electrode plates is large enough and the dielectric constant between the capacitive electrode plates is also large enough, a large plasma liquid-phase capacitor can be obtained by adjusting the distance d between the electrode plates. In the invention, the capacitance of the capacitor is required to be 50-200 uF. In a case where capacitor absorption is used for energy consumption, according to the formula of the capacitor and energy:

$$A = \frac{1}{2} {CU}^{2}$$

(where C is capacitance, and U is voltage), during discharge to plasma,

$$A = \frac{1}{2} {CU}^{2} f ,$$

where f is the frequency; and Trichel pulses generated when the lightning eliminator discharge can produce a discharge frequency f=100 KHZ, and the lightning energy is A=10⁷ J. So, the invention is based on

$$A = \frac{1}{2} {CU}^{2} f = {10}^{7} J ,$$

that is, the lightning eliminator is equivalent to absorbed lightning energy.

First, a liquid-phase dielectric type tank capacitor device with an equivalent capacitance C=100 μF is manufactured, and the area of electrode plates of the capacitor device is S=1600 cm₂;

$$C = \frac{{ε}_{r} \cdot s}{d} ,$$

where d is the distance between the electrode plate and satisfies d=50 cm; upon an actual test, the capacitance of an equivalent capacitor formed by adding a polar dielectric solution such as water, propyl carbonate or CaTiO₃ to the electrode plate is C=101 μF; when the tank diameter is ϕ=50 cm.

The area of a tank opening is S=πR²=3.14×25²=1962.5 cm², and the height of the tank opening is 70 cm.

The DC resistance of the polar dielectric is calculated; when the voltage of lightning electrostatic charges is U=10⁸V, the voltage falls to U=100 kV after lightning energy is absorbed by the capacitor C; and when the discharge current is 100 A,

$$R = \frac{1 {0}^{5}}{100} = 1 k Ω .$$

When the capacitance of the polar dielectric in the tank is regulated to 100 μF, Q=UC according to

$$C = \frac{Q}{U} ;$$

and when Q is constant, the lightning voltage can be decreased. Therefore, when the capacitance of the device is large enough, the lightning head voltage is decreased by 4,000 times, such that when the lead charge is Q=5 and the lightning voltage is 10⁸V, the capacitance of the lightning charge is

$${C}_{0} = \frac{Q}{U} = \frac{5}{1 {0}^{8}} = 5 \times 1 {0}^{- 8} F = 50 \times 1 {0}^{- 9} F = 50 nF ,$$

that is, the initial capacitance of lightning is C₀=50 nF, the capacitance of the device is C=100 μF, and the variation of the capacitance C₀ of the lightning charge and the capacitance C of the device is

$$β = \frac{C}{{C}_{0}} = \frac{100 μF}{50 \times 1 {0}^{- 3}} = 2 \times 1 {0}^{3} ;$$

according to Q=UC, when the lightning voltage is applied to the device, because the capacitance C of the lightning eliminator becomes larger, the lightning voltage U₂ will decrease by 2×10³ times, that is, the lightning voltage decreases from 100,000,000 V=10⁸ V to

$${U}_{2} = \frac{1 {0}^{8}}{2 \times 1 {0}^{3}} = 5 \times 1 {0}^{4} V = 50 kV .$$

That is, the lightning voltage decreases rapidly at this moment, and the voltage of the lightning eliminator is U₂=50 kV.

Energy absorbed by the device is calculated. Assuming the discharge frequency of plasma Trichel pulses generated when lightning pulses act on the lightning absorber is f=1 KHz, and an empirical formula of absorbed energy is calculated according to the RC damping resistor of Westinghouse Electric Corporation in America:

$$A = \frac{1}{2} {CU}^{2} f = \frac{1}{2} \times 100 \times 1 {0}^{- 6} {( 5000 )}^{2} \times 1 {0}^{3} = \frac{1}{2} \times 1 {0}^{4} \times 25 \times 4 \times 1 {0}^{3} = 1.25 \times 1 {0}^{8} J$$

According to the above formula, the energy absorbed by the absorber is 1.25×10⁸ J, which is greater than A₁=10⁷ and reaches the desired design value.

The lightning charge insulating block 1 is a high-voltage insulator or a bushing high-voltage insulator, the insulator is a ceramic insulator or a silicone rubber composite insulator and is able to withstand a voltage over 100 kV, the ground insulation lightning arrester 2 is a metal conductor rod which may be a solid or hollow conductor such as an iron bar, stainless steel rod, a copper bar or an aluminum bar, is mounted at the top of the lightning charge insulating block 1, and is insulated from a ground potential G, the double-conductor coaxial cable has low resistance and is non-inductive as compared with common wires, and the two conductors of the double-conductor coaxial cable are capacitive. The non-inductive (capacitive only) lightning arrester of the lightning conductor can prevent protect communication equipment nearby against severe destruction caused by R-L-C high-frequency resonance resulting from lightning electromagnetic pulses in the lightning conductor and a ground capacitor to, and a high-frequency pulse effect is generated by means of relaxation features of a polarization effect of a dielectric material in a polar dielectric 43 of the lightning energy consumption and absorption device 4 to generate a dipole polarization loss in the polar dielectric 43 to consume lightning field energy, such that the lightning field energy can be effectively consumed, decreasing the potential and lightning current of a lightning residual voltage at the bottom of the lightning conductor, generally from 5 kA-50 kA to hundreds of amperes, and guaranteeing the safety of electronic and electrical equipment around the tower body.

The solid particles are prepared by mixing one, two or more of barium titanate, calcium titanate and calcium copper titanate; or, the solid particles are prepared by mixing any one, two or more of barium titanate, calcium titanate and calcium copper titanate with one, two or more of clay, kaoline and gypsum. Barium titanate, calcium titanate and calcium copper titanate all have a high dielectric constant, and clay, kaoline and gypsum can be mixed with any one, two or more of barium titanate, calcium titanate and calcium copper titanate to reduce the cost; the liquid phase is one or a combination of two or more of water, saline water and propylene carbonate. In use, the liquid phase is mainly prepared from water, and one or a mixed liquid of saline water and propylene carbonate is added to regulate the resistance of the polar dielectric. The liquid phase has a high dielectric constant. In actual implementation, the dielectric constant of the polar dielectric is εᵣ≥50, wherein the dielectric constant of the liquid phase is equal to or greater than 40, the dielectric constant of the solid particles is equal to or greater than 100, and the ratio of a volume fraction of the solid particles to a volume fraction of the liquid phase is 1:1-1:15 to ensure that the mixed liquid has a certain viscosity, so as to allow the prepared liquid-phase polar dielectric has an equivalent capacitance C≥100 uF and an equivalent resistance R>5 kΩ.

The double-conductor coaxial cable comprises, from inside to outside, four layers: an inner core conductor 31, an intermediate insulating layer 32, an outer core conductor 33 and an outer insulating layer 34; and one end of the inner core conductor 31 is connected to one end of the ground insulation lightning arrester 2, the other end of the inner core conductor 31 is connected to said end of the lightning pulse energy consumption and absorption device 4, and the outer core conductor 33 is connected to the grounding terminal. The inner core conductor 31 is a copper core or an aluminum core; because of the high lightning voltage, the intermediate insulating layer 32 is made from polyethylene or crosslinked polyethylene capable of withstanding a high voltage of 50-100 kV; the outer core conductor 33 is made from copper; and the outer insulating layer 34 is made from a plastic-clad material. The installation length of the double-conductor coaxial cable should be greater than 30 m as required to ensure that the capacitance C between the inner core conductor 31 and the outer core conductor 33 is over 20 nF. Coaxial cables have the characteristic of low impedance, and the use of the high-voltage low-impedance coaxial cable as a waveguide channel will not cause side flashes, that is, the residual voltage in lightning traveling waves can be decreased, such that planned redundant energy consumption is realized, and communication equipment nearby can be protected against severe destruction caused by R-L-C high-frequency resonance resulting from lightning electromagnetic pulses in the lightning conductor and the ground capacitor.

In specific implementation, the solid particles further comprise a ferromagnetic material, which is prepared by mixing one, two or more of ferromagnetic ferrite powder, ferroferric oxide powder, ferromagnetic and ferroelectric seignette salt and potassium dihydrogen phosphate. One or more of the materials is mixed with one or more of pyritic clay or ferromagnetic kaoline powder. The magnetic polar dielectric can absorb lightning field energy and then convert the lightning field energy into magnetic field energy to realize an electric energy conversion process, together with the expansion the magnetic liquid.

The capacitive electrode plates are one or more groups of parallel dual-electrode plate structures, and are made from aluminum, copper alloy, titanium or stainless steel. The electrode plates are parallelly arranged opposite to each other in the vertical direction or the horizontal direction, and have a certain area. According to

$$C = \frac{{ε}_{0} {ε}_{r} s}{d} ,$$

the capacitance is in direct proportion to the area of the electrode plates. When lightning absorbers are fabricated, the lightning energy absorption effect should become better with the increase of the capacitance as required. However, due to the limitation on the installation size of equipment on the tower body, the relationship between the area of the electrode plates and the dielectric constant of the polar dielectric should be considered comprehensively.

In specific implementation, the ground insulation lightning arrester is made from stainless steel round steel, generally has a diameter of 10˜20 mm and a length of 3˜5 m, and penetrates through and is fixed in an insulating bushing of the lightning charge insulating block; the lightning charge insulating block is a hollow cavity type insulator (model: FQG-35/6), which is provided with a rain-proof umbrella, prepared from a silicone rubber composite material, and manufactured by Wenzhou Gulifa Group Co., Ltd. in Zhejiang province. The high-voltage low-impedance double-conductor coaxial cable is a high-voltage double-conductor coaxial power cable, specifically a double-conductor cable capable of withstanding a voltage of 35 kV˜110 kV, and the model of the high-voltage power cable is 35 kV, YJLV-62-1×300; the lightning pulse energy consumption and absorption device is a capacitive resistance-capacitance absorber, which has an equivalent capacitance C≥10 uF and a resistance R=5 KΩ˜10 KΩ, and is manufactured by Shanghai Shaobing Electronics Co., Ltd.; and the designed lightning energy absorption capacity of the novel lightning absorber is A≥10⁵ J (Joule)-10⁸ J (Joule), that is, the novel lightning absorber can absorb high-voltage lightning pulse energy of 10⁵ J˜10⁸ J, and the can withstand a voltage U≥1000 kV.

It is obvious for those skilled in the art that the invention is not limited to the details of the above illustrative embodiments, and can be implemented in other specific forms without departing form the spirit or basic features of the invention. Therefore, no matter from which point of view, the embodiments should be construed as illustrative and non-restrictive. The scope of the invention should be defined by the appended claims rather than the above description, and all variations falling within the meanings and scope of equivalents of the claims should fall within the invention. None of the reference signs in the claims should be construed as limitations of the claims involved.

In addition, it should be understood that, although the invention is described with embodiments in this specification, not every embodiment includes only one independent technical solution, and the narrative form in the specification is merely for the purpose of clarity. Those skilled in the art should consider the specification as a whole, and the technical solutions of the embodiments can be properly combined to form other embodiments that can be understood by those skilled in the art.

1. A lightning protection device for electronic equipment on a tower, comprising:
a lightning charge insulating block prepared from a high-voltage insulating material and mounted at a top of the tower;
a ground insulation lightning arrester which is a metal conductor, arranged at a top of the lightning charge insulating block, and insulated from a tower body;
a lightning pulse energy consumption and absorption device, comprising capacitive electrode plates, a polar dielectric, and an insulating tank container, the capacitive electrode plates being symmetrically mounted on two sides of an interior of the insulating tank container, the insulating tank container being filled with polar dielectric, and a high-frequency pulse effect being generated by means of relaxation features of a polarization effect of a dielectric material in the polar dielectric to generate a dipole polarization loss in the polar dielectric to consume lightning field energy; and
a double-conductor coaxial cable, connected to the ground insulation lightning arrester and one end of the lightning pulse energy consumption and absorption device, and configured to lead lightning on the ground insulation lightning arrester to the lightning pulse energy consumption and absorption device, the other end of the lightning pulse energy consumption and absorption device being connected to a grounding terminal.

2. The lightning protection device for the electronic equipment on the tower according to claim 1, wherein the double-conductor coaxial cable comprises, from inside to outside, four layers: an inner core conductor, an intermediate insulating layer, an outer core conductor and an outer insulating layer; and
one end of the inner core conductor is connected to an end of the ground insulation lightning arrester, the other end of the inner core conductor is connected to said end of the lightning pulse energy consumption and absorption device, and the outer core conductor is connected to the grounding terminal.

3. The lightning protection device for the electronic equipment on the tower according to claim 1, wherein the polar dielectric has a dielectric constant εᵣ≥50.

4. The lightning protection device for the electronic equipment on the tower according to claim 1, wherein the polar dielectric is prepared by mixing solid particles with a dielectric constant εᵣ≥100 and a liquid phase with a dielectric constant εᵣ≥40.

5. The lightning protection device for the electronic equipment on the tower according to claim 4, wherein the liquid phase is one or a combination of two or more of water, saline water and propylene carbonate.

6. The lightning protection device for the electronic equipment on the tower according to claim 4, wherein the solid particles are prepared by mixing one, two or more of barium titanate, calcium titanate and calcium copper titanate; or
the solid particles are prepared by mixing any one, two or more of barium titanate, calcium titanate and calcium copper titanate with one, two or more of clay, kaoline and gypsum.

7. The lightning protection device for the electronic equipment on the tower according to claim 4, wherein a ratio of a volume fraction of the solid particles to a volume fraction of the liquid phase is 1:1˜1:15.
